(19) United States
(12) Patent Application Publication
(10) Pub. No.: US 2022/0151267 A1
(43) Pub. Date: May 19, 2022

(54) Microbe-Based Emulsifying Food Additives

(71) Applicant: Locus IP Company, LLC, Solon, OH (US)

(72) Inventors: Sean FARMER, Ft. Lauderdale, FL (US); Ken ALIBEK, Solon, OH (US)

(21) Appl. No.: 17/599,925

(22) PCT Filed: Apr. 15, 2020
(86) PCT No.: PCT/US2020/028290

§ 371 Date: Sep. 29, 2021

Related U.S. Application Data
(60) Provisional application No. 62/834,509, filed on Apr. 16, 2019.

(51) Int. Cl. A23L 3/3571; A23L 29/10; A23L 35/00

(52) U.S. Cl. CPC A23L 3/3571; A23L 35/10; A23L 29/10

(57) ABSTRACT

The subject invention provides stable food products, food additive compositions, and methods for stabilizing and extending the consumable life of food products characterized as dispersions and/or emulsions.

### CROSS-REFERENCE TO RELATED APPLICATION

This application claims priority to U.S. Provisional Patent Application No. 62/834,509, filed Apr. 16, 2019, which is incorporated herein by reference in its entirety.

### BACKGROUND OF THE INVENTION

The food industry is a complex, worldwide collection of industries that supplies a majority of the food consumed by the world's population. From agriculture, to manufacturing, processing and distribution, a variety of players work together to provide food to consumers that is, ideally, safe and palatable.

Many food items must be shipped considerable distances to reach grocery stores and markets where they will ultimately be sold to consumers. Furthermore, once they arrive, the food items must remain shelf stable before purchase. Thus, food additives are often employed to preserve the taste, texture and other organoleptic properties of the food, as well as to prevent spoilage due to natural chemical degradation and/or microbial growth. These food additives can include, for example, flavorings, dyes, stabilizers, preservatives, thickeners, sweeteners, and emulsifiers. Emulsifiers in particular, are commonly added to processed foods, such as dressings, condiments and sauces, as well as ice creams and baked goods, to create a smooth texture, prevent separation and/or settling of immiscible mixture components, and extend shelf life.

Many food items are produced by mixing varying combinations of gases, liquids and/or solids. Dispersions are formed when solid primary particles, agglomerates, or aggregates are distributed uniformly throughout a continuous medium (commonly, a liquid). These particles can range in size from 0.001 μm to 1 μm or greater for suspension dispersions, or between 0.001 μm to 1 μm for colloidal dispersions.

Over time, without stabilizers and/or mechanical homogenization, the solid particles of a suspension will tend to settle out of the liquid phase. Ketchup and mustard, which comprise ground up vegetable particles dispersed in an aqueous phase, are common examples of suspensions. Colloidal dispersions, on the other hand, contain much smaller particles that do not tend to settle out as easily.

An emulsion is another type of mixture, comprising two immiscible liquid phases, such as a fat and a water phase. Emulsions can be achieved by finely dividing one of the phases into small particles, where either the oil is suspended in the water (oil-in-water, O/W) or the water is suspended in the oil (water-in-oil, W/O). Other, more complex emulsion systems can also be formed, such as, for example, oil-in-water-in-oil (O/W/O). Milk is a common example of an O/W emulsion, while margarine is a W/O emulsion. Other food emulsions include mayonnaise, salad dressings and sauces, such as Hollandaise sauce.

Dispersions and emulsions can be produced by applying mechanical force from a blender or homogenizer. The dispersed phase is broken down into miniscule pieces or droplets that are suspended in the continuous phase; however, once homogenized, most emulsions and dispersions require the use of substances (emulsifiers) to stabilize the small particles or droplets in suspension, and to prevent them from coalescing or settling out. For coalescence, in particular, a reduction in interfacial surface area reduces the thermodynamic energy level of the system and favors the joining of separated particles into larger droplets. An emulsifier, also called an emulgent, is a surface-active agent that acts as a border between the droplets or particles to keep them apart and in a dispersed state.

Emulsifiers can include, for example, mustards, soy lecithin, sunflower lecithin, egg, mono- and diglycerides, polysorbates, fatty acid esters, poly hydroxyl substrates, lactic acid, sucrose, sucrose esters, carrageenan, gelatin, starches, pectin, guar gum, locust bean gum, xanthan gum, alginates and proteins.

In the United States, and in many other countries, emulsifiers are required by law to be included in a food's ingredients list. Most concerns about food additives target synthetic ingredients that are added to foods. Many synthetic emulsifiers, including, for example, carboxymethylcellulose (CMC) and polysorbate 80 (P80), are considered undesirable additions to food products by many consumers and food scientists alike. Some synthetic additives are even thought to be the cause of dysbiosis of the gut microbiome, causing inflammation, among other side-effects. (Zelman 2017).

The use of food additives is important for the food industry as well as for consumers who wish to enjoy shelf stable processed foods; however, due to the growing concern over synthetic food additives, safer and more naturally-derived options are needed.

### BRIEF SUMMARY OF THE INVENTION

The subject invention relates to improving the quality and preservation of food products through the use of beneficial microbes and/or their growth by-products. Specifically, the subject invention provides stable food products, food additive compositions, and methods for stabilizing and extending the consumable life of food products characterized as dispersions and/or emulsions.

Advantageously, the microbe-based products and methods of the subject invention are environmentally-friendly and cost-effective. Additionally, in preferred embodiments, the subject invention utilizes components that are biodegradable, toxicologically safe and that meet the requirements for “organic” food status. Furthermore, the present invention can be used as a replacement for synthetic and/or chemical emulsifiers to preserve the quality of processed foods.

In preferred embodiments, the subject invention provides a microbe-based food additive composition that serves a variety of purposes. In some embodiments, the microbe-based food additive serves as an emulsifier and/or a stabilizer.

Advantageously, in certain embodiments, the microbe-based food additive improves the stability of emulsified and/or dispersed food products, as well as prevents the demulsification and/or settling out of the different ingredients, all without negatively altering organoleptic properties, including, for example, the taste, texture, smell and/or color, of the food product.

Furthermore, the microbe-based food additive can create a smoother texture in food products and promote uniform mixing and distribution of the ingredients in batters and doughs. Even further, the food additive can, in certain embodiments, prolong the shelf life of food products, reduce the viscosity of food products, and serve as a non-stick agent for easily releasing baked goods from baking vessels.

In preferred embodiments, the microbe-based food additive comprises one or more microorganisms and/or one or more microbial growth by-products. The microbe-based food additive composition can be obtained through cultivation processes ranging from small to large scale. These cultivation processes include, but are not limited to, submerged cultivation/fermentation, solid state fermentation (SSF), and modifications, hybrids or combinations thereof.

The microbe-based food additive may comprise, for example, live and/or unviable cells, fermentation medium, and/or microbial growth by-products. In one embodiment, the composition comprises the microbial growth by-products separated from the microorganisms that produced them. The growth by-products can be in a purified or unpurified form.

In one embodiment, the microbial growth by-products comprise one or more biologically-derived emulsifying agents. Preferably, the emulsifying agents are biological amphiphilic molecules, including, for example, microbial biosurfactants and biopolymers. Amphiphilic molecules according to the subject invention include, for example, glycolipids, lipopeptides, flavolipids, phospholipids, fatty acid esters, and high-molecular-weight biopolymers such as lipoproteins, lipopolysaccharide-protein complexes, and/or polysaccharide-protein-fatty acid complexes.

In one embodiment, the biological amphiphilic molecules are glycolipids such as, for example, rhamnolipids (RLP), sophorolipids (SLP), cellobiose lipids, trehalose lipids or mannosylerythritol lipids (MEL). In one embodiment, the biological amphiphilic molecules are lipopeptides, such as, for example, surfactin, iturin, fengycin, arthrofactin, viscosin and/or lichenysin. In one embodiment, the biological amphiphilic molecules are other types of amphiphilic molecules, such as, for example, esterified fatty acids, cardiolipins, emulsan, lipomanan, alasan, and/or liposan.

In certain embodiments, the microbe-based food additive comprises a blend of more than one amphiphilic molecule. In certain embodiments, the microbe-based food additive can comprise about 1 ppm to about 10,000 ppm amphiphilic molecule(s). In certain embodiments, the composition can comprise about 0.001 to 5.0%, by weight, amphiphilic molecule(s).

Preferably, the total concentration of biological amphiphilic molecules in the food additive is at critical micelle concentration (CMC).

In some embodiments, the microbe-based food additive comprises microorganisms in addition to the microbial growth by-products. The microbes can be amphiphile-producing yeasts, fungi and/or bacteria in a live or inactive state. In a specific embodiment, the microbes are inactivated prior to being added to the food product.

In one embodiment, the microbe is a yeast, such as, for example, Starmerella bombicola, Saccharomyces cerevisiae, Pseudozyma aphidis, Meyerozyma guilliermondii or Pichia anomala (Wickerhamomyces anomalus). In one embodiment, the microbe is a bacterium, such as, for example, Bacillus subtilis, Bacillus amyloliquefaciens or Bacillus licheniformis.

The microbe-based food additive can also comprise other appropriate additives and/or carriers depending on its formulation and intended use. In certain embodiments, however, the composition does not require a carrier, and can be mixed directly into a food product.

In preferred embodiments, methods are provided for producing a stable emulsion or dispersion, the methods comprising mixing two or more ingredients in the presence of a microbe-based food additive composition of the subject invention. In one embodiment, the stable emulsion or dispersion that is produced is a food product.

In one embodiment, the two or more ingredients comprise a first ingredient and a second ingredient, wherein the first ingredient is dispersed in the second ingredient. Thus, in preferred embodiments, the first ingredient is characterized as the dispersed phase of the emulsion or dispersion, and the second ingredient is the continuous phase of the emulsion or dispersion.

In one embodiment, the first ingredient is characterized as a solid, and the second ingredient is characterized as a liquid. The solid can be, for example, particles of a vegetable, fruit, root, tuber, nut, seed, fiber, algae, or other plant, fungi, earth or animal-based food matter. The particles can range in size from, for example, 0.001 μm to 1 μm or greater.

In one embodiment, the first ingredient and the second ingredient are both liquids. Preferably, the two liquids, i.e., the first liquid and the second liquid, are not the same substance. In certain embodiments, the food product is an O/W emulsion, wherein the first liquid is a fat and/or an oil and the second ingredient is water or another aqueous solution. In certain embodiments, the food product is a W/O emulsion, wherein the first ingredient is water or another aqueous solution and the second liquid is a fat and/or an oil.

In preferred embodiments of the subject method, the microbe-based food additive is first added to the second ingredient (continuous phase), followed by slowly adding the first ingredient (dispersed phase) to the second ingredient while actively mixing.

Preferably, mixing comprises vigorous agitation such that the dispersed phase is broken into small particles or droplets and dispersed uniformly throughout the continuous phase. The microbe-based food additive coats the particles or droplets, thereby stabilizing the emulsion or dispersion.

In some embodiments, mixing is performed using, for example, a mill or a homogenizer machine. In some embodiments, mixing is performed by hand, using, for example, a whisk, blender or membrane emulsifier. In some embodiments, ultrasonic mixing techniques are used, wherein a metal tool vibrates at a high frequency in the mixture to disrupt the dispersed phase into smaller particles or droplets.

In some embodiments, mixing is performed at room temperature, e.g., 20 to 25° C., or under mild, controlled heat, e.g., about 25 to 30° C.

In one embodiment, the subject invention provides food products produced according to the subject methods. Preferably, the food products are mixtures comprising two or more ingredients, as well as a microbe-based food additive of the subject invention.

In certain embodiments, the food product is a sauce, dressing or condiment, for example, barbeque sauce, steak sauce, salad dressing, Hollandaise sauce, mayonnaise, ketchup, or mustard; a dairy product, such as milk, butter, yogurt, ice cream or frozen yogurt, including, for example, novelty ice cream sandwiches and bars; a baked good, such as a cake, cupcake, biscuit or cookie, or the dough or batter thereof prior to baking; a processed meat, such as a sausage; or other food products characterized by the dispersion of particles or droplets of a solid or liquid in a liquid medium.

Additional ingredients, including solids, liquids and/or gases, as well as additional food additives, such as, for example, flavorings, dyes, stabilizers, emulsifiers, preservatives, thickeners, and sweeteners, can also be included in the food product, as can be determined by a food scientist, chef or baker having the benefit of the subject disclosure.

Advantageously, the compositions and methods of the subject invention can be effective for enhancing the quality of food products without negatively altering the taste, smell, appearance and/or texture of the food products.

### DETAILED DESCRIPTION

The subject invention relates to improving the quality and preservation of food products through the use of beneficial microbes and/or their growth by-products. Specifically, the subject invention provides stable food products, food additive compositions, and methods for stabilizing and extending the consumable life of food products characterized as dispersions and/or emulsions.

Advantageously, the microbe-based products and methods of the subject invention are environmentally-friendly and cost-effective. Additionally, in certain embodiments, the subject invention utilizes components that are biodegradable, toxicologically safe and that meet the requirements for “organic” food status. Furthermore, the present invention can be used as a replacement for synthetic and/or chemical emulsifiers to preserve the quality of processed foods.

### Selected Definitions

As used herein, the term “consumable life” means the length of time a product is fit for consumption by humans or other animal subjects. In the context of food products, consumable life includes the length of time the food product is safe for consumption, e.g., able to be consumed by a subject without causing harm to the subject or making the subject ill, and the length of time the food product is palatable, e.g., has not lost characteristics such as nutritional value, taste, smell, texture or appearance that make the food product desirable for consumption.

As used herein, the term “emulsion” refers to a type of mixture comprising two immiscible liquid phases, wherein one of the liquid phases (dispersed phase) is divided into small particles or droplets dispersed throughout the other liquid phase (continuous phase). Typically, one of the liquids is a fat or oil and one is water-based, where either the oil is suspended in the water (oil-in-water, O/W) or the water is suspended in the oil (water-in-oil, W/O). Most emulsions contain dispersed droplets with a diameter of about 1 nm to about 1 μm, or greater, about 10 nm to about 500 nm, or about 100 nm to about 250 nm.

As used herein, the term “dispersion” refers to solid primary particles, agglomerates, or aggregates dispersed uniformly throughout a continuous medium (commonly, a liquid). These particles can range in size from 0.001 μm to 1 μm or greater for “suspension” dispersions, or between 0.001 μm to 1 μm for “colloidal” dispersions.

As used herein, the term “emulsifier” includes the phrase “stabilizer” and refers to a substance that promotes uniform separation and distribution of droplets and/or particles throughout a continuous phase of an emulsion and/or a dispersion, as well as promotes the stability of the emulsion and/or dispersion, thereby preventing coalescence and/or settling out of the dispersed phase.

As used herein, a “biofilm” is a complex aggregate of microorganisms, such as bacteria, wherein the cells adhere to each other and/or to a surface. The cells in biofilms are physiologically distinct from planktonic cells of the same organism, which are single cells that can be motile in a liquid medium or on a solid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. A purified or isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites include, but are not limited to, biosurfactants biopolymers, enzymes, toxins, acids, solvents, alcohols, proteins, peptides, amino acids, lipids, carbohydrates, vitamins, minerals, and microelements.

As used herein, “polymer” refers to any macromolecular compound prepared by bonding one or more similar molecular units, called monomers, together. Polymers include synthetic and biologically-synthesized polymers. Further included in the term polymer is the term “biopolymer” and “biological polymer,” which as used herein, means a natural polymeric substance, or a polymeric substance occurring in a living organism. One characteristic of biopolymers is their ability to biodegrade. Biopolymers can include polynucleotides (e.g., RNA and DNA), polysaccharides (e.g., linearly bonded polymeric carbohydrates), and polypeptides (i.e., short polymers of amino acids).

As used herein, “prevention” means avoiding, delaying, forestalling, or minimizing the onset or progression of a particular occurrence or situation (e.g., coalescence or settling out). Prevention can include, but does not require, absolute or complete prevention, meaning the occurrence or situation may still develop at a later time than it would without preventative measures. Prevention can include reducing the severity and/or extent of the onset of an occurrence or situation, and/or inhibiting the progression of the occurrence or situation to one that is more severe or extensive.

As used herein, “reduces” means a negative alteration, and “increases” means a positive alteration, wherein the alteration is at least 0.001%, 0.01%, 0.1%, 1%, 5%, 10%, 15%, 20%, 25%, 30%, 35%, 45%, 50%, 55%, 60%, 65%, 70%, 75%, 80%, 85%, 90%, 95%, 99%, or 100%, inclusive of all values therebetween.

As used herein, the term “spoilage” means the spoiling, deterioration and/or contamination of a food product to the point that it is inedible, or its quality for edibility becomes reduced. Food that is capable of spoilage is called “perishable food.”

As used herein, “surfactant” means a surface active compound that lowers the surface tension (or interfacial tension) between two liquids or between a liquid and a solid. Surfactants act as, e.g., detergents, wetting agents, emulsifiers, foaming agents, and dispersants. A biosurfactant is a surface active agent produced by a living cell, e.g., a microbe.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example, within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein

Other features and advantages of the invention will be apparent from the following description of the preferred embodiments thereof, and from the claims. All references cited herein are hereby incorporated by reference.

### Microbe-Based Food Additive Compositions

In one embodiment, the subject invention provides microbe-based food additive compositions comprising one or more microorganisms and/or one or more microbial growth by-products. The food additive composition can serve a variety of purposes. In some embodiments, the microbe-based food additive serves as an emulsifier and/or a stabilizer.

Advantageously, in certain embodiments, the microbe-based food additive improves the stability of food products that are characterized as emulsions and/or dispersions, as well as prevents the demulsification and/or settling out of the dispersed ingredients, without negatively altering organoleptic properties, including, for example, the taste, texture, smell and/or color, of the food product.

Additionally, the microbe-based food additive can create a smoother texture in food products and promote uniform mixing and distribution of the ingredients in batters and doughs prior to cooking. Even further, in certain embodiments, the food additive can prolong the shelf life of food products, reduce the viscosity of food products, and/or serve as a non-stick agent for easier release of baked goods from pans.

As used herein, reference to a “microbe-based composition,” for example, a microbe-based food additive composition, means a composition that comprises components that were produced as the result of the growth of microorganisms or other cell cultures. The microbe-based composition can be obtained through cultivation processes ranging from small to large scale. These cultivation processes include, but are not limited to, submerged cultivation/fermentation, solid state fermentation (SSF), and modifications, hybrids or combinations thereof. Thus, the microbe-based composition may comprise the microbes themselves and/or by-products of microbial growth.

If present, the microbes of a microbe-based composition may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In some embodiments, the microbes are present, with medium in which they were grown, in the microbe-based composition. The cells may be present at, for example, a concentration of 1×10⁴, 1×10⁵, 1×10⁶, 1×10⁷, 1×10⁸, 1×10⁹, 1×10¹⁰, 1×10¹¹, 1×10¹², 1×10¹³ or more CFU/milliliter of the composition.

In certain embodiments, the subject microbe-based food additive composition may comprise, for example, live and/or inactive microbial cells, fermentation medium, and/or microbial growth by-products. In one embodiment, the microbial growth by-products are separated from the microorganisms that produced them. The growth by-products can be in a purified or unpurified form. Purification can be performed using known methods, for example, using a rotoevaporator, microfiltration, ultrafiltration, or chromatography.

In one embodiment, the microbial growth by-products are one or more biologically-derived emulsifying agents. Preferably, the emulsifying agents are biological amphiphilic molecules.

Advantageously, the biological emulsifying agents according to the subject composition are non-toxic, biodegradable, and do not emit polluting and/or hazardous substances into the environment or to consumers. Additionally, in preferred embodiments, these compounds exhibit greater thermostability, halostability, and pH stability than chemical stabilizers, such as chemical surfactants.

Furthermore, in certain embodiments, a lower concentration of the biological emulsifying agents is required for stabilizing the emulsion or dispersion than is required by chemical stabilizers.

Amphiphilic molecules consist of two parts: a polar (hydrophilic) moiety and non-polar (hydrophobic) moiety. Due to their structure, these molecules increase the surface area of hydrophobic water-insoluble substances, increase the water bioavailability of such substances, and accumulate at interfaces, thus reducing interfacial tension and leading to the formation of aggregated micellar structures in solution.

Amphiphilic molecules according to the subject invention include, for example, biosurfactants and/or biopolymers. These can include, for example, glycolipids, lipopeptides, flavolipids, phospholipids, fatty acid esters, and high-molecular-weight biopolymers such as lipoproteins, lipopolysaccharide-protein complexes, and/or polysaccharide-protein-fatty acid complexes.

In one embodiment, the biological amphiphilic molecules are glycolipids such as, for example, rhamnolipids (RLP), sophorolipids (SLP), cellobiose lipids, trehalose lipids or mannosylerythritol lipids (MEL). In one embodiment, the biological amphiphilic molecules are lipopeptides, such as, e.g., surfactin, iturin, fengycin, arthrofactin, viscosin and/or lichenysin. In one embodiment, the biological amphiphilic molecules are other types of amphiphilic molecules, such as, for example, esterified fatty acids, cardiolipins, pullulan emulsan, lipomanan, alasan, and/or liposan.

In certain embodiments, the microbe-based food additive comprises a blend of more than one biological amphiphilic molecule. In certain embodiments, the microbe-based food additive can comprise about 1 ppm to about 10,000 ppm biological amphiphilic molecules, or about 10 ppm to about 5,000 ppm, or about 100 ppm to about 1,000 ppm. In certain embodiments, the composition can comprise about 0.001 to 5.0%, by weight, about 0.005% to about 1.0%, about 0.01% to about 0.1%, or about 0.05%, biological amphiphilic molecules.

Preferably, the total concentration of biological amphiphilic molecules in the food additive is at critical micelle concentration (CMC).

In certain embodiments, the food additive composition has a hydrophile-lipophile balance (HLB) value appropriate for the type of emulsion being formed. HLB is the balance of the size and strength of the hydrophilic and lipophilic moieties of a surface-active molecule. In water/oil and oil/water emulsions, the polar moiety of the surface-active molecule orients towards the water, and the non-polar group orients towards the oil, thus lowering the interfacial tension between the oil and water phases. Proper HLB is required for a stable emulsion to be formed.

HLB values range from 0 to 20, with lower HLB (e.g., 10 or less) being more oil-soluble and suitable for water-in-oil emulsions, and higher HLB (e.g., 10 or more) being more water-soluble and suitable for oil-in-water emulsions.

Other biologically-derived emulsifying agents, such as other biopolymers or polysaccharide-based substances (e.g., rubbers, starches, resins, gums, suberin, melanin, lignin, cellulose, xanthan gum, guar gum, welan gum, levan, xylinan, gellan gum, curdlan, pullulan, dextran, alginate), beta-glucans, mannoproteins, acids, solvents, enzymes, and/or proteins, can also be utilized according to the subject invention. These compounds are preferably derived from a living organism, including non-microbial organisms.

In some embodiments, the microbe-based food additive comprises microorganisms in addition to the microbial growth by-products. The microbes can be amphiphile-producing yeasts, fungi and/or bacteria in a live or inactive state. In a specific embodiment, the microbes are inactivated prior to being added to the food product.

The microbe-based food additive food additive can also comprise appropriate additives depending on its formulation and intended use, for example, carriers, buffering agents, other microbe-based compositions produced at the same or different facility, viscosity modifiers, tracking agents, solubility controlling agents, and/or pH adjusting agents. In certain embodiments, however, the microbe-based food additive composition does not require a carrier, and can be mixed directly into a food product as an emulsifier and/or stabilizer.

Additionally, the food additive composition can comprise other microbial growth by-products and/or metabolites that can be useful for improving qualities of food products, including, for example, taste, color, smell, shelf life, viscosity, texture, nutritional content, and moisture content. The additional microbial growth by-products can include, for example, enzymes, solvents, acids, proteins, gases, vitamins, amino acids, antioxidants, peptides, proteins, carbohydrates, lipids and others.

### Growth of Microbes

The subject invention provides methods for cultivation of microorganisms and production of microbial metabolites and/or other by-products of microbial growth. In one embodiment, the subject invention provides materials and methods for the production of biomass (e.g., viable cellular material), extracellular metabolites (e.g. small molecules and secreted proteins), residual nutrients and/or intracellular components (e.g. enzymes and other proteins).

The growth vessel used for growing microorganisms can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of the liquid, and air spargers for supplying bubbles of gas to the liquid for dissolution of oxygen into the liquid.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, isopropyl, propanol, butanol, pentanol, hexanol, isobutanol, and/or glycerol; fats and oils such as soybean oil, rice bran oil, canola oil, olive oil, corn oil, sesame oil, and/or linseed oil; etc. These carbon sources may be used independently or in a combination of two or more.

In one embodiment, the method comprises use of two carbon sources, one of which is a saturated oil selected from canola, vegetable, corn, coconut, olive, or any other oil suitable for use in, for example, cooking. In a specific embodiment, the saturated oil is 15% canola oil or discarded oil that has been used for cooking.

In one embodiment, the microorganisms can be grown on a solid or semi-solid substrate, such as, for example, corn, wheat, soybean, chickpeas, beans, oatmeal, pasta, rice, and/or flours or meals of any of these or other similar substances.

In one embodiment, growth factors and trace nutrients for microorganisms are included in the medium. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, calcium carbonate, sodium chloride and/or sodium carbonate. These inorganic salts may be used independently or in a combination of two or more.

In some embodiments, the method for cultivation may further comprise adding additional acids and/or antimicrobials in the liquid medium before and/or during the cultivation process. Antimicrobial agents or antibiotics are used for protecting the culture against contamination. Additionally, antifoaming agents may also be added to prevent the formation and/or accumulation of foam when gas is produced during cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the liquid medium may be necessary.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention provides methods of producing a microbial metabolite by cultivating a microbe strain of the subject invention under conditions appropriate for growth and production of the metabolite; and, optionally, purifying the metabolite. In a specific embodiment, the metabolite is a biosurfactant. The metabolite may also be, for example, ethanol, lactic acid, beta-glucan, proteins, amino acids, peptides, metabolic intermediates, polyunsaturated fatty acids, and lipids. The metabolite content produced by the method can be, for example, at least 20%, 30%, 40%, 50%, 60%, 70%, 80%, or 90%.

The biomass content of the fermentation medium may be, for example from 5 g/l to 180 g/l or more, or about 10 g/l to 150 g/l.

The microbial growth by-product produced by microorganisms of interest may be retained in the microorganisms or secreted into the growth medium. In another embodiment, the method for producing microbial growth by-product may further comprise steps of concentrating and purifying the microbial growth by-product of interest. In a further embodiment, the medium may contain compounds that stabilize the activity of microbial growth by-product.

The method and equipment for cultivation of microorganisms and production of the microbial by-products can be performed in a batch, quasi-continuous, or continuous processes.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells remains in the vessel as an inoculant for a new cultivation batch. The composition that is removed can be a microbe-free medium or contain cells, spores, mycelia, conidia or other microbial propagules. In this manner, a quasi-continuous system is created.

Advantageously, the methods of cultivation do not require complicated equipment or high energy consumption. The microorganisms of interest can be cultivated at small or large scale on site and utilized, even being still-mixed with their media. Similarly, the microbial metabolites can also be produced at large quantities at the site of need.

### Microbial Strains Grown in Accordance with the Subject Invention

The microorganisms that can be grown according to the subject methods can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In preferred embodiments, the microorganism is an amphiphile-producing yeast or fungus. Examples include, but are not limited to, Acaulospora, Aspergillus, Aureobasidium (e.g., A. pullulans), Blakeslea, Candida (e.g., C. albicans, C. apicola), Debaryomyces (e.g., D. hansenii), Entomophthora, Fusarium, Hanseniaspora (e.g., H. uvarum), Hansenula, Issatchenkia, Kluyveromyces, Mortierella, Mucor (e.g., M. piriformis), Penicillium, Phythium, Phycomyces, Pichia (e.g., P. anomala, P. guielliermondii, P. occidentalis, P. kudriavzevii), Pseudozyma (e.g., P. aphidis), Rhizopus, Saccharomyces (S. cerevisiae, S. boulardii sequela, S. torula), Starmerella (e.g., S. bombicola), Torulopsis, Thraustochytrium, Trichoderma (e.g., T. reesei, T. harzianum, T. vixens), Ustilago (e.g., U. maydis), Wickerhamomyces (e.g., W. anomalus), Williopsis, Zygosaccharomyces (e.g., Z. bailii).

In a specific embodiment, the microbial strain is a Pichia yeast selected from Pichia anomala (Wickerhamomyces anomalus), Pichia guilliermondii (Meyerozyma guilliermondii) and Pichia kudriavzevii. In one embodiment, the yeast or fungus is Starmerella bombicola, Pseudozyma aphidis, or Saccharomyces cerevisiae.

In some embodiments, the microorganisms are bacteria, including Gram-positive and Gram-negative bacteria. Bacteria suitable for use according to the present invention include, for example, Acinetobacter (e.g., A. calcoaceticus, A. venetianus); Agrobacterium (e.g., A. radiobacter), Azotobacter (A. vinelandii, A. chroococcum), Azospirillum (e.g., A. brasiliensis), Bacillus (e.g., B. amyloliquefaciens, B. firmus, B. laterosporus, B. licheniformis, B. megaterium, B. mucilaginosus, B. subtilis, B. coagulans GBI-30 (BC30)), Chlorobiaceae spp., Dyadobacter fermenters, Frankia spp., Frateuria (e.g., F. aurantia), Klebsiella spp., Microbacterium (e.g., M. laevaniformans), Pantoea (e.g., P. agglomerans), Pseudomonas (e.g., P. aeruginosa, P. chlororaphis, P. chlororaphis subsp. aureofaciens (Kluyver), P. putida), Rhizobium spp., Rhodospirillum (e.g., R. rubrum), Sphingomonas (e.g., S. paucimobilis), and/or Xanthomonas spp.

In one embodiment, the microorganism is a Bacillus sp., such as, B. subtilis, B. amyloliquefaciens, or B. licheniformis. In one specific embodiment, the microorganism is B. amyloliquefaciens NRRL B-67928.

Other microbial strains can be used in accordance with the subject invention, including, for example, any other strains having high concentrations of mannoprotein and/or beta-glucan in their cell walls and/or that are capable of producing amphiphilic molecules, biopolymers, or other emulsifying solvents, enzymes, acids or proteins.

### Preparation of Microbe-Based Products

The subject invention provides “microbe-based products,” which are products that are to be applied in practice to achieve a desired result. The microbe-based product of the subject invention is simply the fermentation medium containing the microorganism and/or the microbial metabolites produced by the microorganism and/or any residual nutrients. Alternatively, the microbe-based product may have components removed, or may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

The microorganisms in the microbe-based product may be in an active or inactive form, or the compositions may comprise combinations of active and inactive microorganisms. In some embodiments, the microorganism is inactivated prior to being added to a food product. In some embodiments, the growth by-product of the microorganism is extracted from the medium in which it was produced, and, optionally, purified.

The microbe-based products may be used without further stabilization, preservation, and storage. The microbes, growth by-products and/or medium resulting from the microbial growth can be removed from the growth vessel and transferred via, for example, piping for immediate use. Advantageously, direct usage of these microbe-based products preserves a high viability of the microorganisms, reduces the possibility of contamination from foreign agents and undesirable microorganisms, and maintains the activity of the by-products of microbial growth.

In other embodiments, the composition (microbes, medium, growth by-products, or combinations thereof) can be placed in containers of appropriate size, taking into consideration, for example, the intended use, the contemplated method of application, the size of the fermentation tank, and any mode of transportation from microbe growth facility to the location of use. Thus, the containers into which the microbe-based composition is placed may be, for example, from 1 gallon to 1,000 gallons or more. In other embodiments the containers are 2 gallons, 5 gallons, 25 gallons, or larger.

In certain embodiments, use of unpurified microbial growth by-products according to the subject invention can be superior to, for example, purified microbial metabolites alone, due to, for example, the advantageous properties of the yeast cell walls. These properties include high concentrations of mannoprotein as a part of yeast cell wall's outer surface (mannoprotein is a highly effective bioemulsifier) and the presence of biopolymer beta-glucan (an emulsifier) in yeast cell walls. Additionally, the yeast fermentation product further can comprise biosurfactants and other metabolites (e.g., lactic acid, ethyl acetate, ethanol, etc.) in the culture.

Upon harvesting the microbe-based composition from the growth vessels, further components can be added as the harvested product is placed into containers and/or piped (or otherwise transported for use). The additives can be, for example, buffers, carriers, other microbe-based compositions produced at the same or different facility, viscosity modifiers, preservatives, nutrients for microbe growth, tracking agents, solvents, biocides, other microbes and other ingredients specific for an intended use.

Other suitable additives, which may be contained in the formulations according to the invention, include substances that are customarily used for such preparations. Example of such additives include surfactants, emulsifying agents, lubricants, buffering agents, solubility controlling agents, pH adjusting agents, and stabilizers.

In one embodiment, the composition may further comprise buffering agents including organic and amino acids or their salts. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt or polyprotic acid, such as sodium bicarbonate or carbonate, sodium sulfate, sodium phosphate, sodium biphosphate, can be included in the formulation.

In one embodiment, additional components can be included to increase the efficacy of the treatment products, such as chelating agents and adherents.

Advantageously, in accordance with the subject invention, the microbe-based product may comprise medium in which the microbes were grown. The product may be, for example, at least, by weight, 1%, 5%, 10%, 25%, 50%, 75%, or 100% growth medium. The amount of biomass in the product, by weight, may be, for example, anywhere from 0% to 100% inclusive of all percentages therebetween.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

### Methods of Producing Stable Food Emulsions and/or Dispersions

In preferred embodiments, methods are provided for producing a stable food emulsion or dispersion, wherein the methods comprise mixing two or more ingredients in the presence of a microbe-based food additive composition of the subject invention.

As used herein, “stability” of an emulsion or dispersion refers to resistance to changes in the physiochemical properties of the emulsion or dispersion. In other words, stability is the emulsion or dispersion's ability to resist forces acting thereon that cause sedimentation (dispersed phase moves downward), creaming (dispersed phase moves upward), flocculation/aggregation of dispersed phase particles or droplets, coalescence of dispersed phase droplets or particles, and/or phase inversion (e.g., W/O becomes O/W).

In one embodiment, the two or more ingredients comprise a first ingredient and a second ingredient, wherein the first ingredient is dispersed in the second ingredient. Thus, in preferred embodiments, the first ingredient is characterized as the dispersed phase of the emulsion or dispersion, and the second ingredient is the continuous phase of the emulsion or dispersion.

In one embodiment, the first ingredient is characterized as a solid, and the second ingredient is characterized as a liquid. The solid can be, for example, particles of a vegetable, fruit, herb, spice, root, tuber, nut, seed, fiber, algae, or other plant, fungi, earth or animal-based food matter. The particles can range in size from, for example, 0.001 μm to 1 μm or greater.

In one embodiment, the first ingredient and the second ingredient are both liquids. Preferably, the two liquids, i.e., the first liquid and the second liquid, are not the same substance. In certain embodiments, the food product is an O/W emulsion, wherein the first liquid is a fat and/or an oil and the second ingredient is water or another aqueous solution. In certain embodiments, the food product is a W/O emulsion, wherein the first ingredient is water or another aqueous solution and the second liquid is a fat and/or an oil.

In preferred embodiments of the subject method, the microbe-based food additive is first added to the second ingredient (continuous phase), followed by slowly adding the first ingredient (dispersed phase) to the second ingredient while actively mixing.

Preferably, mixing comprises vigorous agitation such that the dispersed phase is broken into small particles or droplets and dispersed uniformly throughout the continuous phase. The microbe-based food additive coats the particles or droplets, thereby stabilizing the emulsion or dispersion.

In some embodiments, mixing is performed using, for example, a mill or a homogenizer machine. In some embodiments, mixing is performed by hand, using, for example, a whisk, blender or membrane emulsifier. In some embodiments, ultrasonic or supersonic mixing techniques are used, wherein, for example, a metal tool vibrates at a high frequency in the mixture to disrupt the dispersed phase into smaller particles or droplets.

In some embodiments, mixing is performed at room temperature, e.g., 20 to 25° C., or under mild, controlled heat, e.g., about 25 to 30° C. In certain embodiments, once formed, the food emulsion or dispersion is able to remain stable, even at widely varying temperatures.

Advantageously, the compositions and methods of the subject invention can be effective for enhancing the quality of food products without negatively altering the taste, smell, appearance and/or texture of the food products.

In certain embodiments, addition of the microbe-based food additive according to the subject methods serves to increase the amount of time the emulsion or dispersion is stable by, for example, at least 1 minute, 60 minutes, 1 day, 30 days, 1 month, 2 months, 3 months, 4 months, or longer, depending on, for example, the shelf-life of the food product.

In some embodiments, the methods can be implemented in combination with, or alongside, other methods of improving the quality of food products, as well as for improving the stability of food emulsions or dispersions. For example, additional ingredients, including solids, liquids and/or gases, as well as additional food additives, such as, for example, flavorings, dyes, stabilizers, emulsifiers, preservatives, thickeners, and sweeteners, can also be included in the food product.

In some embodiments, the subject method can be used to reduce the viscosity of certain food products by at least 0.1%, at least 1.0%, at least 10%, at least 50%, at least 100%, at least 200%, or more. Advantageously, in foods where extra oils and/or fats are typically added to reduce viscosity, the amount of such extra oils and/or fats can be reduced, thus reducing the cost and the calorie content of the food product.

The methods of the subject invention can be implemented anywhere that food products are produced. The two or more ingredients and microbe-based food additive can be stored in separate vessels onsite. When the need for the food product arises, the ingredients and food additive can be collected and/or piped directly into one vessel and homogenized therein. In one embodiment, the method is implemented at or near a site (e.g., less than 300, 250, 200, 150, 100, 75, 50, 25, 15, 10, 5, 3, or 1 mile from the site) where, food products are produced.

In one embodiment, the method is implemented in a large scale food processing plant. In one embodiment, the method is implemented in a commercial bakery or restaurant. In one embodiment, the method is implemented in a home kitchen by every day consumers.

Advantageously, the compositions and methods of the subject invention utilize components that are biodegradable and toxicologically safe, and can serve as replacements for potentially harmful food additive, such as, for example, CMC or polysorbates. Thus, the present invention can be used for improving the quality of food emulsions or dispersions as a “green” additive, and, in some embodiments, can even be utilized for “organic” food products.

### Food Products

In one embodiment, the subject invention provides food products produced according to the subject methods. Preferably, the food products are mixtures (e.g., emulsions and/or dispersions) comprising two or more ingredients, as well as a microbe-based food additive of the subject invention.

In one embodiment, the two or more ingredients comprise a first ingredient and a second ingredient, wherein the first ingredient is dispersed in the second ingredient. Thus, in preferred embodiments, the first ingredient is characterized as the dispersed phase of the emulsion or dispersion, and the second ingredient is the continuous phase of the emulsion or dispersion.

In one embodiment, the first ingredient is characterized as a solid, and the second ingredient is characterized as a liquid. The solid can be, for example, particles of a vegetable, fruit, root, tuber, nut, seed, fiber, or other plant, fungi, earth or animal-based food matter. The particles can range in size from, for example, 0.001 μm to 1 μm or greater.

In one embodiment, the first ingredient and the second ingredient are both liquids. Preferably, the two liquids, i.e., the first liquid and the second liquid, are not the same substance. In certain embodiments, the food product is an O/W emulsion, wherein the first liquid is a fat and/or an oil and the second ingredient is water or another aqueous solution. In certain embodiments, the food product is a W/O emulsion, wherein the first ingredient is water or another aqueous solution and the second liquid is a fat and/or an oil.

As used herein, the term “food product” refers to any substance, preparation, composition or object that is suitable for consumption, nutrition, oral hygiene or pleasure, and which are intended to be introduced into the human or animal oral cavity, to remain there for a certain period of time and then to either be swallowed or to be removed from the oral cavity again (e.g., chewing gum).

These products include all substances or products intended to be ingested by humans or animals in a processed (e.g., cereals) or a semi-processed (e.g., butchered meat) state. This also includes substances that are added to orally consumable products (particularly food and pharmaceutical products) during their production, treatment or processing and intended to be introduced into the human or animal oral cavity.

Food products according to the subject invention include processed and/or semi-processed products, such as, for example: baked goods (e.g., bread, biscuits, cake, cookies, and other pastries), sweets (e.g., chocolates, chocolate bar products, other bar products, fruit gum, coated tablets, hard candies, toffees and caramels, and chewing gum), non-alcoholic beverages (e.g., cocoa, coffee, green tea, black tea, black or green tea beverages enriched with extracts of green or black tea, Rooibos tea, other herbal teas, fruit-containing lemonades, isotonic beverages, soft drinks, nectars, fruit and vegetable juices, and fruit or vegetable juice preparations), instant beverages (e.g., instant cocoa beverages, instant tea beverages, and instant coffee beverages), cereal products (e.g., breakfast cereals, muesli bars, and pre-cooked instant rice products), dairy products (e.g., whole fat or fat reduced or fat-free milk beverages, rice pudding, yoghurt, kefir, cream cheese, soft cheese, hard cheese, dried milk powder, whey, butter, buttermilk, partly or wholly hydrolyzed products containing milk proteins, ice creams, frozen yogurts, novelty ice cream bars and sandwiches), non-dairy milk beverages (e.g., soy milk, nut milks, oat milk, baby formulas), products from soy protein or other soy bean fractions (e.g., soy milk and products prepared thereof, beverages containing isolated or enzymatically treated soy protein, soy flour containing beverages, preparations containing soy lecithin, fermented products such as tofu or tempeh products prepared thereof and mixtures with fruit preparations and, optionally, flavoring substances), fruit preparations (e.g., jams, fruit ice cream, fruit sauces, and fruit fillings), vegetable preparations, sauces and/or dressings (e.g., mayonnaise, remoulade, Hollandaise sauce, barbeque sauce, steak sauce, hot chili sauce, ketchup, mustard, or horseradish sauce), snack articles (e.g., baked or fried potato chips (crisps) or potato dough products, and extrudates on the basis of maize or peanuts), bread products (e.g., sliced bread, rolls, tortillas and muffins), ready-made meals, smoothies and soups (e.g., weight-loss/meal-replacement smoothies, nutritional protein drinks, dry soups, instant soups, and pre-cooked soups), processed meats (e.g., sliced deli meats, sausages, pates, canned meats), and/or nut butters (e.g., almond butter, peanut butter, soy nut butter, cashew butter, hazelnut butter).

The ingredients utilized in producing the food products can be food products themselves, as well as salts, leavening agents (e.g., baking soda, baking powder, cream of tartar), acids (e.g., acetic acid, lactic acid, carbonic acid), extractions and/or oils (e.g., yeast extract, vegetable oils, nut oils, seed oils, ghee, essential oils), sugars (e.g., cane sugar, refined sugar, corn syrups), flours, and/or meals. The ingredients can also include fresh foods, including fresh foods that are minimally-processed, such as dried, frozen, or canned forms. “Fresh” foods include, for example, nuts, seeds (e.g., mustard, sunflower, sesame, quinoa, chia, flax), fruits (e.g., stone fruits, berries, melons, citrus, tomato, drupes, dry and fleshy fruits), vegetables (e.g., bulb, flower, legume, tuber, leafy, stem and root vegetables), algae, seaweed, fungi (e.g., mushrooms, dried yeast), herbs, grains (e.g., wheat, corn, rice, millet, sorghum, oats), meat (e.g., poultry, sausage, beef, lamb, pork and wild game), seafood (e.g., fish, shellfish, squid, mollusks), and eggs or egg products (e.g., egg whites and/or egg yolks).

Additional ingredients characterized as solids, liquids and/or gases, as well as, for example, flavorings, dyes, stabilizers, emulsifiers, preservatives, acidulents, anticaking agents, antifoaming/foaming agents, antioxidants, glazing agents, humectants, thickeners, and/or sweeteners, can also be included in the food product, as can be determined by a food scientist, chef or baker having the benefit of the subject disclosure.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application (e.g., at a food processing plant). The facility produces high-density microbe-based compositions in batch, quasi-continuous, or continuous cultivation.

The microbe growth facilities of the subject invention can be located at the location where the microbe-based product will be used. For example, the microbe growth facility may be less than 300, 250, 200, 150, 100, 75, 50, 25, 15, 10, 5, 3, or 1 mile from the location of use.

The microbe growth facilities of the subject invention produce fresh microbe-based compositions comprising the microbes themselves, microbial metabolites, and/or other components of the medium in which the microbes are grown. If desired, the compositions can have a high density of vegetative cells or propagules, or a mixture of vegetative cells and propagules.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. The system is efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

In one embodiment, the microbe growth facility is located on, or near, a site where the microbe-based products will be used, for example, within 300 miles, 200 miles, or even within 100 miles. Advantageously, this allows for the compositions to be tailored for use at a specified location. The formula and potency of microbe-based compositions can be customized for a specific application and in accordance with the local conditions at the time of application.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Mayonnaise

A vegan mayonnaise can be produced according to the methods of the subject invention. Typically, to prepare mayonnaise, egg yolk serves as an emulsifier because of, for example, the naturally occurring lecithin it contains. The egg yolk is mixed with an aqueous acid, such as vinegar or lemon juice (water continuous phase). Then, an oil, such as vegetable oil or olive oil (dispersed phase), is slowly mixed in with the egg yolk-acid mixture to create an O/W emulsion.

By substituting the egg yolk for a microbe-based food additive composition according to the subject invention, the resulting food product is a vegan-friendly mayonnaise that contains no animal-derived products. Furthermore, the method allows for reduced calorie and fat content compared with when eggs are used.

### REFERENCES

Clark, J. P. (2013). Emulsions: When Oil and Water Do Mix. IFJ. Vol. 67, No. 8. http://www.ift.org/food-technology/past-issues/2013/august/columns/processing-1.aspx?page=2.

Suggs, J. L., et al. Food Emulsifiers. U.S. Pat. No. 4,310,557 A. Issued Jan. 12, 1982.

Zelman, K. (2017). Food Additives: Emulsifiers. Food & Nutrition. https://foodandnutrition.org/november-december-2017/food-additives-emulsifiers/.

1. A food product comprising a mixture of two or more ingredients and a microbe-based food additive, said microbe-based food additive comprising one or more microorganisms and/or one or more microbial growth by-products,
wherein said one or more microorganisms are live or inactive cells of an amphiphile-producing yeast, fungus and/or bacterium, and, optionally, a carrier, and
wherein said one or more microbial growth by-products are amphiphilic molecules.

2. The food product of claim 1, which is an emulsion or a dispersion.

3. The food product of claim 1, wherein the two or more ingredients comprise a first ingredient and a second ingredient, and wherein the first ingredient is dispersed in the second ingredient.

4. The food product of claim 3, wherein the first ingredient is a solid, and the second ingredient is a liquid.

5. The food product of claim 4, wherein the solid comprises particles of a vegetable, fruit, root, tuber, nut, seed, fungus, algae or fiber.

6. The food product of claim 5, wherein the particles are 0.001 μm to 1 μm in size.

7. The food product of claim 3, wherein the first ingredient is a first liquid and the second ingredient is a second liquid, said first liquid being different from said second liquid.

8. The food product of claim 7, wherein the first liquid is a fat and/or an oil, and the second ingredient is water or an aqueous solution.

9. The food product of claim 7, wherein the first ingredient is water or an aqueous solution and the second liquid is a fat and/or an oil.

10. The food product of claim 1, wherein the amphiphilic molecules are one or more biosurfactants and/or biopolymers.

11. The food product of claim 10, wherein the amphiphilic molecules are glycolipids, lipopeptides, flavolipids, phospholipids, fatty acid esters, lipoproteins, lipopolysaccharide-protein complexes, and/or polysaccharide-protein-fatty acid complexes.

12. The food product of claim 11, wherein the glycolipids are sophorolipids, rhamnolipids, trehalose lipids, cellobiose lipids and/or mannosylerythritol lipids.

13. The food product of claim 11, wherein the lipopeptides are surfactin, iturin, fengycin, arthrofactin, viscosin and/or lichenysin.

14. The food product of claim 10, wherein the amphiphilic molecules are esterified fatty acids, cardiolipins, emulsan, lipomanan, alasan, and/or liposan.

15. The food product of claim 1, wherein the one or more microorganisms are yeasts selected from Starmerella bombicola, Saccharomyces cerevisiae, Pseudozyma aphidis, Meyerozyma guilliermondii and Pichia anomala (Wickerhamomyces anomalus).

16. The food product of claim 1, wherein the one or more microorganisms are bacteria selected from Bacillus subtilis, Bacillus amyloliquefaciens and Bacillus licheniformis.

17. The food product of claim 1, wherein the microorganisms are inactivated.

18. The food product of claim 1, comprising the one or more microbial growth by-products without the one or more microorganisms.

19. The food product of claim 1, wherein the one or more microbial growth by-products are purified.

20. The food product of claim 1, wherein the microbe-based food additive serves as an emulsifier and/or a stabilizer without negatively altering taste, texture, smell and/or color of the food product.

21. The food product of claim 1, which is a sauce, a dressing, a condiment, a dairy product, a baked good, or a processed meat.

22. (canceled)

23. The food product of claim 21, wherein the food product is a milk, cream, butter, yogurt, ice cream, or frozen yogurt.

24-25. (canceled)

26. The food product of claim 1, further comprising additional ingredients and/or food additives selected from flavorings, dyes, stabilizers, emulsifiers, preservatives, thickeners, and sweeteners.

27. A method for producing a food product characterized as an emulsion or dispersion, the method comprising mixing two or more ingredients in the presence of a microbe-based food additive,
wherein the two or more ingredients comprise a first ingredient and a second ingredient,
wherein the food additive comprises one or more microorganisms and/or one or more microbial growth by-products, said one or more microorganisms comprising live or inactive cells of an amphiphile-producing yeast, fungus and/or bacterium, and, optionally, a carrier, and said one or more microbial growth by-products comprising amphiphilic molecules.

28. The method of claim 27, wherein the amphiphilic molecules comprise one or more biosurfactants and/or biopolymers.

29. The method of claim 28, wherein the amphiphilic molecules are glycolipids, lipopeptides, flavolipids, phospholipids, lipoproteins, lipopolysaccharide-protein complexes, and/or polysaccharide-protein-fatty acid complexes.

30. The method of claim 29, wherein the glycolipids are sophorolipids, rhamnolipids, trehalose lipids, cellobiose lipids and/or mannosylerythritol lipids.

31. The method of claim 29, wherein the lipopeptides are surfactin, iturin, fengycin, arthrofactin, viscosin and/or lichenysin.

32. The method of claim 28, wherein the amphiphilic molecules are esterified fatty acids, cardiolipins, emulsan, lipomanan, alasan, and/or liposan.

33. The method of claim 27, wherein the one or more microorganisms are yeasts selected from Starmerella bombicola, Saccharomyces cerevisiae, Pseudozyma aphidis, Meyerozyma guilliermondii and Pichia anomala (Wickerhamomyces anomalus).

34. The method of claim 27, wherein the one or more microorganisms are bacteria selected from Bacillus subtilis, Bacillus amyloliquefaciens and Bacillus licheniformis.

35-36. (canceled)

37. The method of claim 27, wherein the one or more microbial growth by-products are purified.

38. The method of claim 27, wherein the first ingredient is the dispersed phase of the emulsion or dispersion and the second ingredient is the continuous phase of the emulsion or dispersion.

39. The method of claim 27, wherein the first ingredient is characterized as a solid, and the second ingredient is characterized as a liquid.

40. The method of claim 39, wherein the solid comprises particles of a vegetable, fruit, root, tuber, nut, seed, fungus, algae or fiber.

41. The method of claim 40, wherein the particles are 0.001 μm to 1 μm in size.

42. The method of claim 27, wherein the first ingredient is a first liquid and the second ingredient is a second liquid, said first liquid being different from said second liquid.

43. The method of claim 42, wherein the first liquid is a fat and/or an oil, and the second ingredient is water or an aqueous solution.

44. The method of claim 42, wherein the first ingredient is water or an aqueous solution and the second liquid is a fat and/or an oil.

45. The method of claim 27, comprising first adding the microbe-based food additive to the second ingredient, then slowly adding the first ingredient to the second ingredient while actively mixing.

46. The method of claim 45, wherein the mixing is performed using a mill, a homogenizer machine, a whisk, a blender, a membrane emulsifier or an ultrasonic mixing tool.

47. The method of claim 27, wherein the mixing is performed at 20 to 30° C.
